(19) United States
(12) Patent Application Publication
(10) Pub. No.: US 2008/0205979 A1
(43) Pub. Date: Aug. 28, 2008

(54) Device For Compensating For Tolerances When Fastening an Add-On to a Base Member

(75) Inventors: Stephane Gombert, Claix (FR); Steve Mouchet, Grenoble (FR)

Correspondence Address: BAKER & DANIELS LLP;111 E. WAYNE STREET, SUITE 800, FORT WAYNE, IN, 46802, US

(73) Assignee: A. RAYMOND ET CIE, Grenoble (FR)

(21) Appl. No.: 11/814,188

(22) PCT Filed: Nov. 8, 2005
(86) PCT No.: PCT/EP05/11916

§ 371 Date: Jul. 18, 2007

(30) Foreign Application Priority Data
Jan. 21, 2005 (DE) 102005002881.0

(51) Int. Cl. F16B 2/00; F16B 21/00

(52) U.S. Cl. 403/326

(57) ABSTRACT

A device for compensating for tolerances when fastening an add-on to a base member comprises a holding element (1) connectable to the base member, and an elongate compensating bushing (8) that is associated with the add-on, is displaceable relative thereto, and comprises a channel (11) for accommodating a connecting element connectable to the add-on. The holding element (1) and the compensating bushing (8) are freely displaceably associated with each other via wall sections (6, 7) that are smooth over a displacement path. The channel (11) of the compensating bushing (8) has a larger dimension in a direction transverse to the longitudinal direction than the diameter of a connecting element. The holding element (1) is configured as bendable in at least one intermediate section located between a fastening region (2) to the base member and an accommodating region for the compensating bushing (8). This results in excellent tolerance compensation characteristics combined with ease of installation.

### BACKGROUND OF THE INVENTION

1. Field of the Invention

The present invention relates to a device for compensating for tolerances when fastening an add-on to a base member.

2. Description of the Related Art

Such a device is known from DE 201 19 112 U1. The prior device comprises an elongate holding element that is connectable in a front end portion to a base member by means of a connecting element configured in the insertion direction as a screw with an external thread. The holding element is provided with an internal thread that cooperates with an external thread of an elongate compensating bushing. The compensating element is in turn provided with an internal thread, formed in a channel into which the connecting element can be screwed. By screwing the compensating bushing out of the holding element until it butts against an add-on, it is possible to compensate for tolerances with regard to a varying space between the base member and the add-on. Disadvantages of this device, however, are that it is comparatively laborious to unscrew the compensating bushing from the holding element and that tolerance adjustment is available in the longitudinal direction only.

### SUMMARY OF THE INVENTION

The object of the invention is to disclose a device of the initially cited kind that is distinguished by particularly distinctive tolerance compensation characteristics, combined with very simple installation.

This object is achieved according to the invention, in a device as described hereinbelow.

The features that the compensating bushing is freely displaceable in the holding element, the channel is broadened in the transverse direction, and an intermediate section is present that is flexible within certain limits achieve the effects of very fast, simple installation and of tolerance compensation not only in the longitudinal direction, but also in the transverse direction and with respect to tilting.

Further suitable configurations of the invention are the subject matter of the dependent claims.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a perspective view of a first exemplary embodiment of a device according to the invention, comprising a compensating bushing inserted in a holding element and configured with two rim flanges;

FIG. 2 is a perspective view of a holding element in a second exemplary embodiment of a device according to the invention; and

FIG. 3 is a perspective view of a compensating bushing according to the second exemplary embodiment, configured with one rim flange and latching lugs.

Corresponding reference characters indicate corresponding parts throughout the several views. Although the exemplifications set out herein illustrate embodiments of the invention, in several forms, the embodiments disclosed below are not intended to be exhaustive or to be construed as limiting the scope of the invention to the precise forms disclosed.

### DETAILED DESCRIPTION

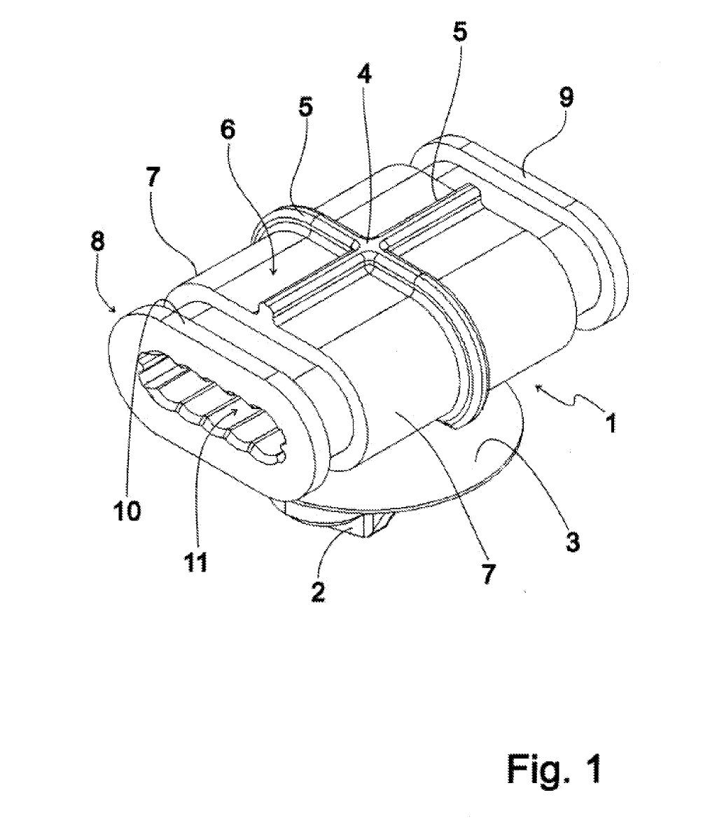

FIG. 1 is a perspective view of a first exemplary embodiment of a device according to the invention. The exemplary embodiment according to FIG. 1 comprises a one-piece holding element 1, made of a plastic material, that can be connected to a base member by means of a fastening foot 2 disposed in a fastening region (not shown in FIG. 1) by inserting the fastening foot 2 in a clearance in the base member; in the inserted arrangement, a support plate 3 of holding element 1 rests against the base member.

In addition, holding element 1 is configured with an elongate mounting sleeve 4, which is connected to fastening foot 2 via an intermediate section which in the first exemplary embodiment is relatively flexible, particularly bendable, substantially by virtue of the choice of material. Mounting sleeve 4 comprises on the outside an arrangement of outer reinforcing ribs 5, which extend for example in both the longitudinal and the transverse direction, as in the illustrated exemplary embodiment, and strengthen the mounting sleeve 4. Mounting sleeve 4 is configured with two rectangular cover sections 6, oriented parallel to each other and serving as wall sections, whose long sides lie in the longitudinal direction and which are joined edgewise to each other via semicircular edge sections 7, also forming wall sections. In the first exemplary embodiment, cover sections 6 and edge sections 7 are configured with smooth, flat surfaces.

In the exemplary embodiment according to FIG. 1, inserted in mounting sleeve 4 is a compensating bushing 8 made of a more rigid plastic material than holding element 1, with the inner wall of mounting sleeve 4 circumferentially surrounding the also smooth outer wall of compensating bushing 8. The dimension of compensating bushing 8 in the longitudinal direction of the inventive device according to FIG. 1 is greater than that of mounting sleeve 4, each of the two ends of compensating bushing 8 being provided with a respective outwardly protruding rim flange 9, 10. Each rim flange 9, 10 thus forms an abutment to limit the displacement of compensating bushing 8 in the longitudinal direction.

Compensating bushing 8 is configured with a longitudinally extending inner channel 11 comprising a broadening, transverse to the longitudinal direction, that is greater than the diameter of a connecting element, preferably in the form of a screw with a self-tapping thread, which can be inserted into channel 11 in order to join the add-on (not shown in FIG. 1) to the base member. In the exemplary embodiment shown, channel 11 has in the broadened, transverse direction a corrugated inner wall, such that the connecting element enters into engagement with compensating bushing 8, for example by means of a thread, with relatively high pull-out force.

The production of the holding element 1 and the compensating bushing 8 according to the first exemplary embodiment takes place in a so-called two-component process (2C process) using two different non-mutually-adhesive materials.

Thus, in the device according to the invention, by virtue of the longitudinal displaceability of compensating bushing 8 in mounting sleeve 4, the relative flexibility of the intermediate section and the relatively large broadening of the channel 11 in the transverse direction, efficient tolerance compensation is obtained in several directions, combined with ease of installation of both ends of the compensating bushing 8.

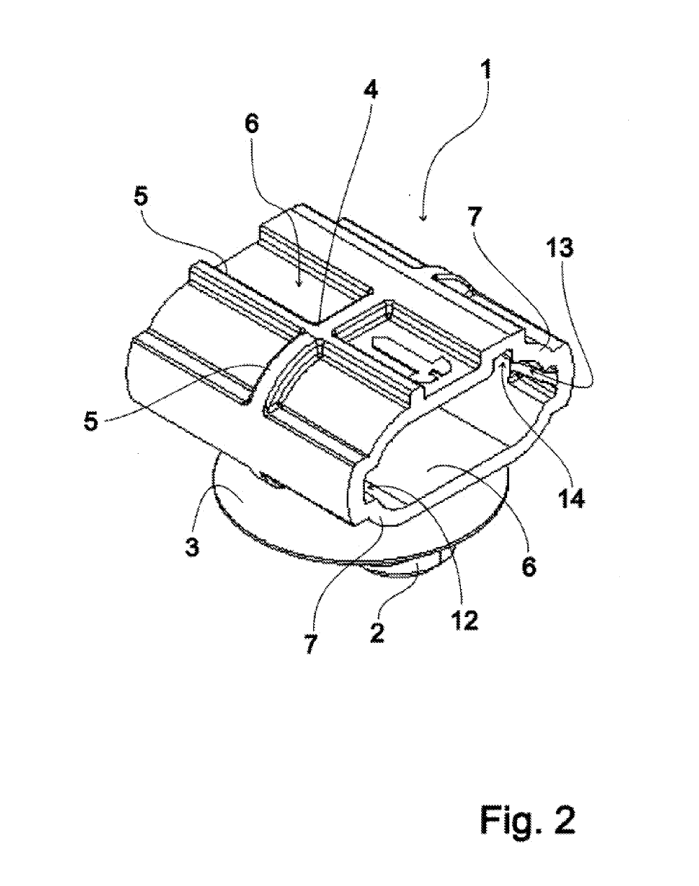

FIG. 2 is a perspective view of a holding element 1 of a second exemplary embodiment of a device according to the invention, whose basic shape is substantially the same as that of holding element 1 of the first exemplary embodiment, illustrated in FIG. 1. For this reason, mutually corresponding elements in FIG. 1 and FIG. 2 are provided with the same respective reference numerals and will not be described further in connection with the second exemplary embodiment.

In deviation from the holding element 1 according to FIG. 1, the holding element 1 of FIG. 2 comprises at its edges two longitudinally extending edge grooves 12, 13, which are configured in the edge sections 7 and extend longitudinally inward from an end face. In addition, formed in a cover section 6 disposed oppositely from fastening foot 2 is an also longitudinally extending cover groove 14, which extends over the entire length of cover section 6 and is asymmetrically arranged.

In the holding element 1 of the second exemplary embodiment according to FIG. 2, the geometry of the attachment of mounting sleeve 4 to fastening foot 2, for example a taper in the material, is substantially responsible for the bendability of mounting sleeve 4 with respect to fastening foot 2.

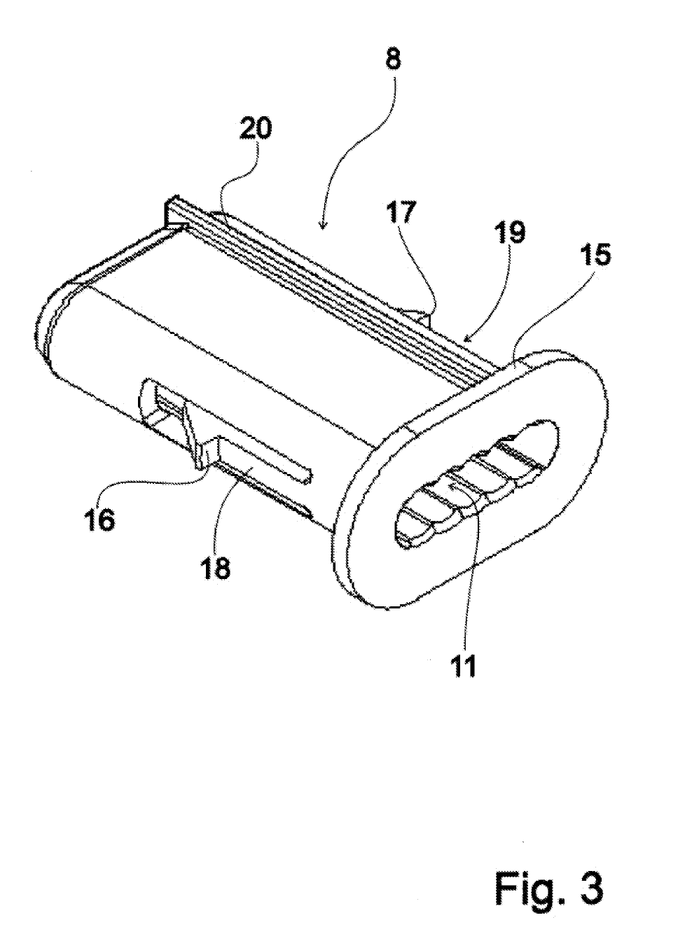

FIG. 3 is a perspective view of a compensating bushing 8 of the second exemplary embodiment, whose basic shape is substantially the same as that of compensating bushing 8 in the first exemplary embodiment, illustrated in FIG. 1. In the second exemplary embodiment, compensating bushing 8 is configured as shorter in comparison to the length of mounting sleeve 4 than is the compensating bushing 8 of the first exemplary embodiment. In addition, in the second exemplary embodiment, the material of compensating bushing 8 is the same as the material of holding element 1.

Compensating bushing 8 is provided with a single rim flange 15 serving as an abutment, and comprises on its sides two latching lugs 16, 17, which protrude from the outer contour and are attached via resilient tongues 18, 19.

In addition, the compensating bushing 8 of the second exemplary embodiment is configured with a elongate guide rail 20 that protrudes from the cover side, extends over the entire length of compensating bushing 8 and is also arranged asymmetrically in the same manner as cover groove 14.

In the fitted-together arrangement, latching lugs 16, 17 engage after being fitted into edge grooves 12, 13 and deflecting into recesses formed in edge sections 7, thereby forming an additional abutment, besides rim flange 15, to prevent compensating bushing 8 from being withdrawn from mounting sleeve 4.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-6. (canceled)

7. A device for compensating for tolerances when fastening an add-on to a base member, said device comprising a holding element (1) adapted to be connected to a said base member, an elongate compensating bushing (8) associated with said holding element (1) and displaceable relative thereto, said bushing (8) including a channel (11) for accommodating a connecting element, said holding element (1) and said compensating bushing (8) freely displaceably associated with one another via two wall sections (6, 7) which are smooth over a displacement path, said channel (11) having a larger dimension in a direction transverse to the longitudinal displacement direction than the diameter of a said connecting element, said holding element (1) configured as bendable at least in an intermediate section located between a fastening region (2) to the base member and an accommodating region for said compensating bushing (8).

8. The device of claim 7, wherein said channel (11) has a corrugated inner wall in the broadened, transverse direction.

9. The device of claim 7, wherein said holding element (1) comprises a mounting sleeve (4) circumferentially surrounding said compensating bushing (8).

10. The device of claim 9, wherein said compensating bushing (8) has two ends and includes an outwardly protruding rim flange (10, 15) at one said end.

11. The device of claim 10, wherein said compensating bushing (8) comprises an outwardly protruding rim flange (9) at a second said end.

12. The device of claim 9 wherein said compensating bushing (8) includes an outwardly protruding latching lug (16, 17) which can be brought into engagement with an engaging structure configured on said holding element (1), thereby limiting the relative movement of said holding element (1) and said compensating bushing (8) in at least one direction.
